(19) United States
(12) Patent Application Publication
(10) Pub. No.: US 2026/0045064 A1
(43) Pub. Date: Feb. 12, 2026

(54) CLUSTERING-BASED OCCUPANCY DETECTION DEVICE AND METHOD

(71) Applicant: Electronics and Telecommunications Research Institute, Daejeon (KR)

(72) Inventor: Jae Ik JEONG, Daejeon (KR)

(21) Appl. No.: 19/268,923

(22) Filed: Jul. 14, 2025

(30) Foreign Application Priority Data
Aug. 9, 2024 (KR) 10-2024-0107174
Jan. 16, 2025 (KR) 10-2025-0006966

(51) Int. Cl. G06V 10/762; G06V 10/26; G06V 10/80; G06V 20/52; G06V 40/20

(52) U.S. Cl. CPC G06V 10/763; G06V 10/273; G06V 10/803; G06V 20/52; G06V 40/20

(57) ABSTRACT

The present invention relates to a clustering-based occupancy detection device which includes: an input module configured to collect image data captured by a camera; a preprocessing unit configured to perform a preprocessing operation for removing unnecessary information from the image data collected by the input module so that only occupants remain; and a clustering unit configured to detect positions of the occupants based on the image data preprocessed by the preprocessing unit.

### CROSS-REFERENCE TO RELATED APPLICATION

This application claims priorities to and the benefits of Korean Patent Applications No. 10-2024-0107174, filed on Aug. 9, 2024, and No. 10-2025-0006966, filed on Jan. 16, 2025, the disclosure of which is incorporated herein by reference in its entirety.

This application claims priority under 35 U.S.C § 119 to Korean Patent Application No. 10-2024-0107174, filed on Aug. 9, 2024, and No. 10-2025-0006966, filed on Jan. 16, 2025, in the Korean Intellectual Property Office, the entire contents of which are hereby incorporated by reference.

### BACKGROUND

### 1. Field of the Invention

The present invention relates to a clustering-based occupancy detection device and method for detecting occupancy based on clustering techniques using unsupervised learning.

### 2. Discussion of Related Art

In modern smart buildings, offices, and residential spaces, occupancy detection technology plays an important role in energy efficiency and space utilization optimization. In particular, utilizing occupancy information can optimize the operation of systems such as lighting, heating, and ventilation, thereby reducing energy consumption and improving user convenience.

For this reason, research and technology development related to occupancy detection are continuously being conducted.

Passive infrared (PIR) sensors and ultrasonic sensors have been widely used as the existing occupancy detection methods. The PIR sensors generate signals in response to movement, but have the limitation that they cannot detect occupancy when there is no movement. Ultrasonic sensors detect occupancy through the reflection of ultrasonic waves, but the accuracy of detection can be reduced due to signal distortion by objects or walls.

Recently, with the development of artificial intelligence (AI) and computer vision technology, object detection algorithms such as You Only Look Once (YOLO) have been introduced to the field of occupancy detection. The YOLO algorithm provides a powerful function of detecting and tracking objects in real time based on image or video data, but it has the following problems.

For example, since the YOLO algorithm requires high-performance hardware and a high-performance memory, it is often difficult to use this algorithm in environments with limited resources. In addition, since YOLO-based systems require a large amount of labeled learning data to be optimized for a specific environment, there is a problem of inefficiency in terms of time and cost.

Accordingly, a technology that can more accurately detect the number of occupants based on a clustering technique based on unsupervised learning is needed.

Accordingly, a technology that can more accurately detect occupancy based on a clustering technique based on unsupervised learning is needed.

The background technology of the present invention is disclosed in Korean Laid-open Patent No. 10-2023-0130365 (published on Sep. 12, 2023).

### SUMMARY OF THE INVENTION

The present invention is directed to a clustering-based occupancy detection device and method that can resolve the high resource requirements and dependency on labeled training of the existing YOLO-based occupancy detection method and enable efficient and accurate occupancy detection even in low-power environments by utilizing unsupervised learning-based clustering techniques.

According to an aspect of the present invention, there is provided a clustering-based occupancy detection device including: an input module configured to collect image data captured by a camera; a preprocessing unit configured to perform a preprocessing operation for removing unnecessary information from the image data collected by the input module so that only occupants remain; and a clustering unit configured to detect positions of the occupants based on the image data preprocessed by the preprocessing unit.

In the present invention, the input module may collect image data captured by a time of flight (ToF) camera installed at an entrance.

In the present invention, the preprocessing unit may generate an image containing only the occupants by removing obstacles from an image of each frame using a basic image without an occupant or by cropping only an area near an entrance.

In the present invention, the preprocessing unit may generate the basic image without an occupant in advance to remove obstacles, compare the image of each frame with the basic image to detect differences, and regenerate the basic image when positions or shapes of the obstacles change.

In the present invention, the clustering unit may generate a cluster centered on a specific area such as the head of the occupant using a mean shift algorithm.

In the present invention, the clustering unit may analyze depth data of the ToF camera and model the shape of the occupant in the form of a Gaussian function to calculate a clustering center corresponding to the position of the occupant.

In the present invention, the clustering unit may convert the image generated by the preprocessing unit into a two-dimensional (2D) array, and form data points centered on coordinates having large values in the 2D array based on a fact that areas with shorter light reflection times in the ToF image have higher values and areas with longer reflection times have lower values.

In the present invention, the clustering-based occupancy detection device may further include a boxing unit configured to generate a bounding box surrounding the occupants based on a center of a cluster detected by the clustering unit, wherein the boxing unit may set a size of the box by utilizing a standard deviation of a Gaussian distribution with respect to the center of the cluster.

In the present invention, the boxing unit may dynamically adjust the size and a position of the bounding box according to movement of the occupant while the size and position are set from the center of the cluster to a boundary of the bounding box, and the bounding box may be used as a basic unit for tracking an entry, exit, and movement path of the occupant.

In the present invention, the clustering-based occupancy detection device may further include a tracking unit configured to track a movement path of the occupant based on the bounding box generated by the boxing unit, wherein the tracking unit may compare a current frame of the occupant with a previous frame based on a SORT algorithm to track a movement direction and whether the occupant has entered or exited in real time.

In the present invention, the tracking unit may continuously monitor the movements of occupants, count the number of occupants passing through an entrance based on tracking results of the occupants, and calculate a total number of occupants staying inside a room.

According to another aspect of the present invention, there is provided a clustering-based occupancy detection method, including: collecting, by an input module, image data captured by a camera; performing, by a preprocessing unit, a preprocessing operation for removing unnecessary information from the image data collected by the input module so that only occupants remain; and detecting, by a clustering unit, positions of the occupants based on the image data preprocessed by the preprocessing unit.

In the present invention, the collecting of the image data may include collecting the image data captured by a ToF camera installed at an entrance.

In the present invention, the performing of the preprocessing may include generating, by the preprocessing unit, an image containing only the occupants by removing obstacles from the image of each frame using a basic image without an occupant or by cropping only an area near an entrance.

In the present invention, the performing of the preprocessing may further include, by the preprocessing unit, generating the basic image without an occupant in advance to remove obstacles, comparing an image of each frame with the basic image to detect differences, and regenerating the basic image when positions or shapes of the obstacles change.

In the present invention, the detecting of the positions of the occupants may include generating, by the clustering unit, a cluster centered on a specific area such as the head of the occupant using a mean shift algorithm.

In the present invention, the detecting of the positions of the occupants may further include, by the clustering unit, analyzing depth data of a ToF camera, modeling a shape of the occupant in a form of a Gaussian function, and calculating a clustering center corresponding to the position of the occupant.

In the present invention, the detecting of the positions of the occupants may further include, by the clustering unit, converting the image generated by the preprocessing unit into a 2D array, and forming data points centered on coordinates having large values in the 2D array based on a fact that areas with shorter light reflection times in a ToF image have higher values and areas with longer reflection times have lower values.

In the present invention, the clustering-based occupancy detection method may further include, after the detecting of the positions of the occupants, generating, by a boxing unit, a bounding box surrounding the occupants based on a center of a cluster detected by the clustering unit, wherein the boxing unit may set a size of the box by utilizing a standard deviation of a Gaussian distribution with respect to the center of the cluster.

In the present invention, the generating of the bounding box may include dynamically adjusting, by the boxing unit, the size and a position of the bounding box according to the movement of the occupant while the size and position are set from the center of the cluster to a boundary of the bounding box, and the bounding box may be used as a basic unit for tracking an entry, exit, and movement path of the occupant.

In the present invention, the clustering-based occupancy detection method may further include, after the detecting of the positions of the occupants, tracking, by a tracking unit, the movement path of the occupant based on the bounding box generated by the boxing unit, wherein the tracking unit may compare a current frame of the occupant with a previous frame based on a SORT algorithm to track a movement direction and whether the occupant has entered or exited in real time, count the number of occupants passing through an entrance and exit based on tracking results of the occupants, and calculate a total number of occupants staying inside a room.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram illustrating a schematic configuration of a clustering-based occupancy detection device according to an embodiment of the present invention;

FIG. 2 is a flowchart for describing a clustering-based occupancy detection method according to an embodiment of the present invention;

FIGS. 3A and 3B are exemplary diagrams illustrating image data collected by an input module in FIG. 2;

FIGS. 4A and 4B are exemplary diagrams illustrating an image preprocessed by a preprocessing unit in FIG. 2; and

FIGS. 5A and 5B are exemplary diagrams illustrating the results of performing clustering and detection, by a clustering unit in FIG. 2, based on a single density center shown in FIG. 5A and multiple density centers shown in FIG. 5B by applying a mean shift algorithm.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

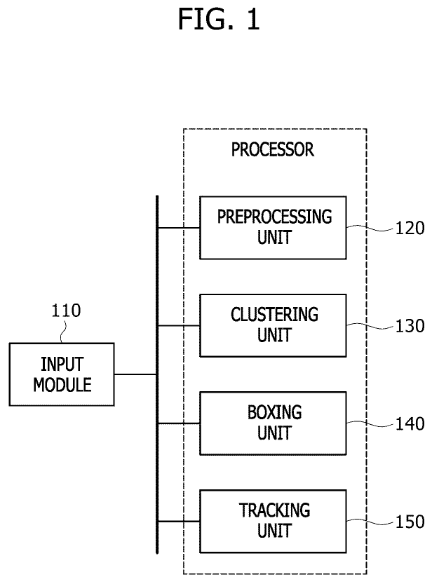

FIG. 1 is an exemplary diagram illustrating a schematic configuration of a clustering-based occupancy detection device according to an embodiment of the present invention.

Referring to FIG. 1, the clustering-based occupancy detection device according to the present embodiment may include an input module 110, a preprocessing unit 120, a clustering unit 130, a boxing unit 140, and a tracking unit 150.

Here, the preprocessing unit 120, the clustering unit 130, the boxing unit 140, and the tracking unit 150 may be integrated into a single processor or may be implemented as multiple processors for each function.

The input module 110 collects image data captured by a time of flight (ToF) camera installed at the entrance.

Here, since the ToF camera calculates the time for light to be reflected from an object and return to generate depth data, thereby effectively detecting the position and shape of the occupant without a high-resolution image.

The input module 110 may transmit necessary data such as the movement of the occupant and depth information to the processor.

The preprocessing unit 120 may perform a task of removing unnecessary information so that only the occupants remain based on the data (e.g., image data) collected by the input module 110.

For example, the preprocessing unit 120 may remove obstacles (e.g., walls, fixed objects, etc.) from the image of each frame by utilizing a basic image without occupants, or generate an image containing only occupants by cropping only an area near the entrance. In addition, data containing noise may be corrected or smoothed to increase the accuracy of clustering.

The preprocessing unit 120 may extract only the area containing the occupants from the input image data and remove unnecessary objects and obstacles to generate image data suitable for clustering in order to improve the performance of the clustering algorithm.

The preprocessing unit 120 may perform preprocessing by analyzing the image data received from the input module 110 so that only the occupants remain.

For example, in this embodiment, since the occupants are detected based on clustering without labeling, it is essential to preprocess the image so that only the occupants are included in the image.

Accordingly, the preprocessing unit 120 removes obstacles such as objects or walls from the image so that only occupants remain, and since there is no function to identify the type of object, obstacle removal is essential for increasing the accuracy of clustering.

For example, the preprocessing unit 120 may generate a basic image without occupants in advance to remove obstacles, compare the image of each frame with the basic image to detect differences (presence or absence of occupants), and regenerate the basic image when the positions or shapes of the obstacles change. In addition, the preprocessing unit 120 may crop only the area near the entrance from the image to generate data containing only occupants, and this method may work effectively only when there are no obstacles in the space near the entrance.

When special circumstances arise, such as the entry and exit of a large object, it is necessary to reset the occupancy count, thereby allowing users to prepare for situations where the obstacle removal method may temporarily lose accuracy.

The clustering unit 130 detects the position of the occupant based on the preprocessed image data.

The clustering unit 130 may generate a cluster centered on a specific area, such as the head of the occupant, using the mean shift algorithm.

Here, the mean shift algorithm is an unsupervised learning-based clustering algorithm that finds the center of density of data and operates by repeatedly shifting data to converge on the center (mode) of high data density. The mean shift algorithm is used in clustering, object tracking, etc., and can effectively detect the center of density of non-standard data in particular. In this embodiment, the mean shift algorithm can be used to detect the center (e.g., head) of the occupant by performing clustering based on the data of the occupant generated from the ToF camera.

The clustering unit 130 may analyze the depth data of the ToF camera to model the shapes of the occupants in the form of a Gaussian function and calculate the clustering center. In this process, the number of occupants can be automatically identified without having to define the number of clusters in advance. In this case, the center of the cluster indicates the positions of the occupants.

The clustering unit 130 may detect objects based on the image generated by the preprocessing unit 120.

In this case, object detection is performed through a clustering algorithm, and in this embodiment, the number of occupants can be identified using an algorithm that can learn the number of clusters.

Here, the clustering algorithms may be largely divided into algorithms that require defining the number of clusters in advance and algorithms that do not require defining the number of clusters in advance.

In this embodiment, since the number of occupants is variable, the algorithm that does not require defining the number of clusters in advance is suitable. Algorithms that meet these conditions include DBSCAN and the mean shift algorithm.

In this embodiment, considering the characteristics of the ToF image, a mean shift-based clustering algorithm can be used. The mean shift method is suitable for modeling the shape of the occupant in the ToF image using a Gaussian function, and clustering may be performed by utilizing the Gaussian function as a kernel function.

The clustering unit 130 converts the image generated by the preprocessing unit 120 into a two-dimensional (2D) array. In this case, areas (close areas) with shorter light reflection times in the ToF image have higher values and areas (distant areas) with longer reflection times have lower values. In addition, data points are generated around coordinates with larger values in the 2D array, and these data points are concentrated around the head of the occupant.

In addition, the clustering unit 130 detects the density center of the data points by applying the mean shift clustering algorithm, and the head of each occupant is determined as the cluster center as the result of the clustering. The clustering center formed accordingly can be interpreted as the detected occupant.

For reference, the ToF image data is easy to be modeled into the form of a Gaussian function, and a Gaussian kernel is used in the mean shift algorithm to detect the cluster center, thereby performing high-accuracy clustering. In addition, in this embodiment, clustering is performed in the form of a 2D Gaussian function.

The boxing unit 140 may generate a bounding box surrounding the occupant based on the center of the cluster detected by the clustering unit 130.

The boxing unit 140 may set the size of the box by utilizing the standard deviation of the Gaussian distribution based on the cluster center.

For example, the boxing unit 140 may set the boundary of the bounding box to a distance of 2× standard deviations from the cluster center with a reliability level of 95%. In this case, the size and position of the bounding box can be dynamically adjusted according to the movement of the occupant. Through this process, the position of the occupant can be visually expressed and utilized for subsequent tracking work.

The boxing unit 140 may perform the function of generating a bounding box for detecting and tracking occupants.

In this embodiment, in order to count the number of occupants using the ToF camera installed at the entrance, tracking of occupants is required, and for this purpose, a bounding box generation process may be included.

For reference, the existing YOLO algorithm automatically generates a bounding box after detecting an object, but the clustering algorithm according to this embodiment is different in that it only detects the cluster center. The boxing unit 140 may expand this cluster center into the bounding box and convert the bounding box so that the occupant can be visually identified.

In this case, the bounding box may be generated in a rectangular shape, and its center may be set to the clustering center (the center of the occupant). In addition, the length of the bounding box may be set to a distance of 2× standard deviations from the mean (cluster center) of the Gaussian function, and this setting corresponds to a reliability level of 95%, and may be flexibly changed depending on the situation. In addition, the size and position of the bounding box may be adjusted depending on the situation, and the setting may be changed depending on the characteristics of the ToF image and the movement of the occupant.

The bounding box generated by the boxing unit 140 may be provided as basic data for the tracking algorithm used in the tracking unit 150. Thereafter, the bounding box can be utilized as a basic unit for tracking the entry, exit, and movement path of the occupant.

The tracking unit 150 may track the movement path of the occupant based on the bounding box generated by the boxing unit 140.

The tracking unit 150 may track the movement direction of the occupant and the entry and exit of the occupant in real time by comparing the current frame of the occupant with the previous frame based on a simple online and realtime tracking (SORT) algorithm.

The tracking unit 150 may count the number of occupants passing through the entrance based on the tracking result and calculate the total number of occupants staying inside the room. Through this process, the movement of the occupants can be continuously monitored, and accurate occupant data can be produced.

The tracking unit 150 may perform the function of tracking the movement path of the occupant based on the bounding box generated by the boxing unit 140. Through this, the change in the position of the occupant and the entry and exit situation can be accurately identified, and the number of occupants inside the room can be counted.

The tracking unit 150 may track the movement path of the occupant using the SORT algorithm.

In this case, the SORT algorithm may identify the movement direction of each occupant, newly appearing occupants, and occupants that disappeared from the image by comparing the data of the current frame and the previous frame.

Since the bounding box generated by the boxing unit 140 is used similarly to the existing YOLO algorithm, the SORT algorithm may be performed in the same manner as applied in the existing YOLO+SORT algorithm. This has the effect of maintaining clustering-based efficiency while utilizing the existing verified algorithm.

The tracking unit 150 may detect the movement of occupants entering or leaving the room in real time, and based on this, accurately record the entry and exit situation of occupants and count the total number of occupants staying inside the room.

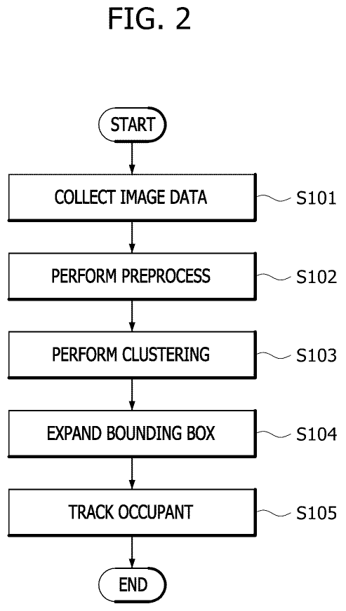

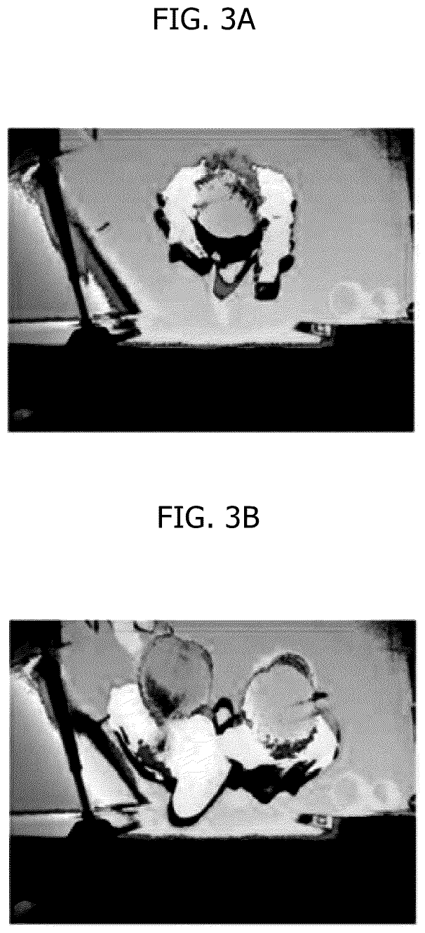

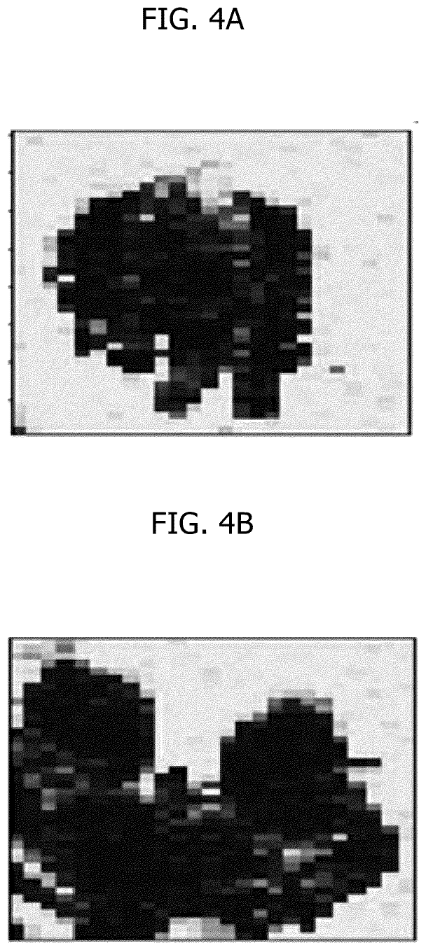

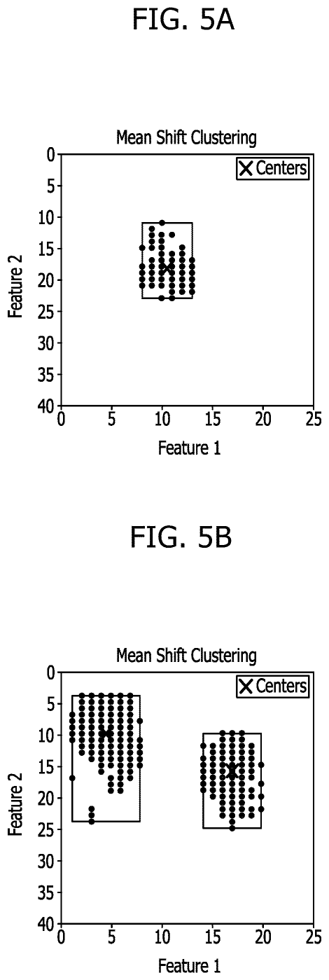

FIG. 2 is a flowchart for describing a clustering-based occupancy detection method according to an embodiment of the present invention. FIGS. 3A and 3B are exemplary diagrams illustrating image data collected by an input module in FIG. 2. FIGS. 4A and 4B are exemplary diagrams illustrating an image preprocessed by a preprocessing unit in FIG. 2. FIGS. 5A and 5B are exemplary diagrams illustrating the results of performing clustering and detection, by a clustering unit in FIG. 2, based on a single density center shown in FIG. 5A and multiple density centers shown in FIG. 5B by applying a mean shift algorithm.

Referring to FIG. 2, in operation S101, the input module 110 may collect image data of the entrance area through a time of flight camera (see FIGS. 3A and 3B).

The ToF camera may generate depth data by calculating the time for light to be reflected from an object and return.

The input module 110 may transmit the collected image data to the processor.

In this case, the image data collected by the input module 110 may include depth information.

In operation S102, the preprocessing unit 120 may perform preprocessing to remove unnecessary objects (e.g., obstacles, walls, etc.) based on the data collected from the input module 110 (see FIGS. 4A and 4B).

For example, the preprocessing unit 120 may utilize a basic image without occupants, compare each frame with the basic image to detect differences (e.g., presence or absence of occupants), and also generate data containing only occupants by cropping only the area near the entrance. In addition, the preprocessing unit 120 may convert the image data into a form suitable for clustering through noise removal and smoothing.

In this manner, the preprocessing unit 120 may output the image data containing only the occupants through preprocessing.

In operation S103, the clustering unit 130 may perform clustering based on the data generated by the preprocessing unit 120.

The clustering unit 130 detects the center of data density (mode) using the mean shift algorithm, and analyzes the depth data of the ToF camera to form a cluster centered on the head of the occupant (see FIGS. 5A and 5B).

The cluster center formed at this time indicates the location of the occupant.

In operation S104, The boxing unit 140 may expand the cluster center generated by the clustering unit 130 into a bounding box.

The bounding box is generated in a rectangular shape, and the center is set to the cluster center.

The size of the bounding box may be set to a distance of 2× standard deviations from the mean of the Gaussian function and is flexibly adjusted depending on the situation.

The generated bounding box visually expresses the location of the occupant and is used for tracking tasks.

In this manner, the bounding box indicates the location and size of the occupant.

In operation S105. the tracking unit 150 performs a SORT algorithm based on the bounding box generated by the boxing unit 140 and tracks the occupants by comparing the current frame and the previous frame data, thereby identifying the movement direction of the occupants, whether a new occupant appears, and whether an existing occupant leaves.

The tracking unit 150 may count the total number of occupants staying inside the room in real time by analyzing the entry and exit situations of the occupants.

In this manner, the tracking unit 150 may output the movement path of the occupant and real-time occupant data.

Compared to the existing YOLO-based occupancy detection method, according to the present embodiment, a lightweight clustering algorithm can be used so that high-performance hardware is not required and occupants can be efficiently detected even in a low-power environment.

According to the present embodiment, it is possible to detect occupants without labeled learning data by utilizing a clustering technique based on unsupervised learning, thereby significantly reducing data preparation time and cost and increasing real-time applicability.

According to the present embodiment, it is possible to accurately detect the locations and movements of occupants in various environments by utilizing the depth information of the ToF camera and maintain high reliability under various conditions through flexible settings of obstacle removal and clustering.

According to an aspect of the present invention, it is possible to resolve the high resource requirements and dependency on labeled training of the existing YOLO-based occupancy detection method and efficiently and accurately detect occupancy even in low-power environments by utilizing unsupervised learning-based clustering techniques.

What is claimed is:

1. A clustering-based occupancy detection device comprising:
an input module configured to collect image data captured by a camera;
a preprocessing unit configured to perform a preprocessing operation for removing unnecessary information from the image data collected by the input module so that only occupants remain; and
a clustering unit configured to detect positions of the occupants based on the image data preprocessed by the preprocessing unit.

2. The clustering-based occupancy detection device of claim 1, wherein the input module collects image data captured by a time of flight (ToF) camera installed at an entrance.

3. The clustering-based occupancy detection device of claim 1, wherein the preprocessing unit generates an image containing only the occupants by removing obstacles from an image of each frame using a basic image without an occupant or by cropping only an area near an entrance.

4. The clustering-based occupancy detection device of claim 3, wherein the preprocessing unit generates the basic image without an occupant in advance to remove obstacles, compares the image of each frame with the basic image to detect differences, and regenerates the basic image when positions or shapes of the obstacles change.

5. The clustering-based occupancy detection device of claim 1, wherein the clustering unit generates a cluster centered on a specific area such as the head of the occupant using a mean shift algorithm.

6. The clustering-based occupancy detection device of claim 5, wherein the clustering unit analyzes depth data of a time of flight (ToF) camera and models the shape of the occupant in a form of a Gaussian function to calculate a clustering center corresponding to the position of the occupant.

7. The clustering-based occupancy detection device of claim 5, wherein the clustering unit converts the image generated by the preprocessing unit into a two-dimensional (2D) array, and forms data points centered on coordinates having large values in the 2D array based on a fact that areas with shorter light reflection times in a time of flight (ToF) image have higher values and areas with longer reflection times have lower values.

8. The clustering-based occupancy detection device of claim 1, further comprising:
a boxing unit configured to generate a bounding box surrounding the occupants based on a center of a cluster detected by the clustering unit,
wherein the boxing unit sets a size of the box by utilizing a standard deviation of a Gaussian distribution with respect to the center of the cluster.

9. The clustering-based occupancy detection device of claim 8, wherein the boxing unit dynamically adjusts the size and a position of the bounding box according to movement of the occupant while the size and position are set from the center of the cluster to a boundary of the bounding box, and
the bounding box is used as a basic unit for tracking an entry, exit, and movement path of the occupant.

10. The clustering-based occupancy detection device of claim 1, further comprising:
a tracking unit configured to track a movement path of the occupant based on a bounding box generated by the boxing unit,
wherein the tracking unit compares a current frame of the occupant with a previous frame based on a simple online and realtime tracking (SORT) algorithm to track a movement direction and whether the occupant has entered or exited in real time, and
by continuously monitoring the movements of occupants, counts the number of occupants passing through an entrance based on tracking results of the occupants, and calculates a total number of occupants staying inside a room.

11. A clustering-based occupancy detection method comprising:
collecting, by an input module, image data captured by a camera;
performing, by a preprocessing unit, a preprocessing operation for removing unnecessary information from the image data collected by the input module so that only occupants remain; and
detecting, by a clustering unit, positions of the occupants based on the image data preprocessed by the preprocessing unit.

12. The clustering-based occupancy detection method of claim 11, wherein the collecting of the image data includes collecting the image data captured by a time of flight (ToF) camera installed at an entrance.

13. The clustering-based occupancy detection method of claim 11, wherein the performing of the preprocessing includes generating, by the preprocessing unit, an image containing only the occupants by removing obstacles from the image of each frame using a basic image without an occupant or by cropping only an area near an entrance.

14. The clustering-based occupancy detection method of claim 13, wherein the performing of the preprocessing further includes, by the preprocessing unit, generating the basic image without an occupant in advance to remove obstacles, comparing an image of each frame with the basic image to detect differences, and regenerating the basic image when positions or shapes of the obstacles change.

15. The clustering-based occupancy detection method of claim 11, wherein the detecting of the positions of the occupants includes generating, by the clustering unit, a cluster centered on a specific area such as the head of the occupant using a mean shift algorithm.

16. The clustering-based occupancy detection method of claim 15, wherein the detecting of the positions of the occupants further includes, by the clustering unit, analyzing depth data of a time of flight (ToF) camera, modeling a shape of the occupant in a form of a Gaussian function, and calculating a clustering center corresponding to the position of the occupant.

17. The clustering-based occupancy detection method of claim 15, wherein the detecting of the positions of the occupants further includes, by the clustering unit, converting the image generated by the preprocessing unit into a 2D array, and forming data points centered on coordinates having large values in the 2D array based on a fact that areas with shorter light reflection times in a time of flight (ToF) image have higher values and areas with longer reflection times have lower values.

18. The clustering-based occupancy detection method of claim 11, further comprising, after the detecting of the positions of the occupants:
generating, by a boxing unit, a bounding box surrounding the occupants based on a center of a cluster detected by the clustering unit,
wherein the boxing unit sets a size of the box by utilizing a standard deviation of a Gaussian distribution with respect to the center of the cluster.

19. The clustering-based occupancy detection method of claim 18, wherein the generating of the bounding box includes dynamically adjusting, by the boxing unit, the size and a position of the bounding box according to movement of the occupant while the size and position are set from the center of the cluster to a boundary of the bounding box, and
the bounding box is used as a basic unit for tracking an entry, exit, and movement path of the occupant.

20. The clustering-based occupancy detection method of claim 11, further comprising, after the detecting of the positions of the occupants:
tracking, by a tracking unit, the movement path of the occupant based on the bounding box generated by the boxing unit,
wherein the tracking unit compares a current frame of the occupant with a previous frame based on a simple online and realtime tracking (SORT) algorithm to track a movement direction and whether the occupant has entered or exited in real time, counts the number of occupants passing through an entrance and exit based on tracking results of the occupants, and calculates a total number of occupants staying inside a room.
